(19) United States
(12) Patent Application Publication
(10) Pub. No.: US 2026/0349067 A1
(43) Pub. Date: Nov. 5, 2026

(54) ASSIGNING AN INSTALLATION LOCATION FOR EACH ONE OF A PLURALITY OF ELECTRONIC LOCKS

(71) Applicant: ASSA ABLOY AB, Stockholm (SE)

(72) Inventors: Tomas Jonsson, Rönninge (SE); Lakshmi Mullassery, Kista (SE); Annea Barkefors, Nacka (SE)

(21) Appl. No.: 19/488,162

(22) PCT Filed: May 21, 2024
(86) PCT No.: PCT/EP2024/063960

§ 371 Date: Nov. 26, 2025

(30) Foreign Application Priority Data
Jun. 1, 2023 (SE) 2350672-8

(51) Int. Cl. G01S 5/02; G07C 9/00

(52) U.S. Cl. CPC G01S 5/0289; G07C 9/00174

(57) ABSTRACT

It is provided method for assigning an installation location for each one of a plurality of electronic locks (12a-g), the method being performed in a position determiner (1), the method comprising: obtaining (42) a distance and a direction between a pair of electronic locks, based on the radio transceivers of the pair of electronic locks; storing (45) an identifier of each electronic lock (12a-g) of the pair, the distance and the direction; determining (48) a derived map (4) of the electronic locks (12a-g) of the pairs; obtaining (50) a reference map (5) comprising installation locations (13a-g), the reference map (5) covering an area in which the electronic locks (12a-g) are installed; and assigning (52), based on the derived map (4) and the reference map (5), the identifier of each one of the electronic locks (12a-g) to one of the installation locations (13a-g) in the reference map (5).

### TECHNICAL FIELD

The present disclosure relates to the field of electronic locks and in particular to assigning an installation location for each one of a plurality of electronic locks

### BACKGROUND

A typical building floor can comprise tens or hundreds of rooms, each with an electronic lock to control access for authorized personnel and guests. Mechanical installation and software configuration of new locks require the responsible personnel to go through a rather intricate procedure. The installation personnel navigates across an unfamiliar floorplan, making frequent stops to install the locks.

Because each lock corresponds to a specific physical space with different access control rules, it is important to ensure a correct mapping between the identity of a lock and its installation location. The locksmith thus shoulders the extra burden of taking note of the identifier of each installed electronic lock as well as its location. Another or the same person then inputs the pairings into configuration software before uploading different commissioning data to the access control system. The locks can then assume their respective roles in providing access control to different areas in the building.

The procedure for assigning locks to installation locations is complicated and prone to errors. It would be of great benefit if this procedure can be improved.

### SUMMARY

One object is to improve the assigning of an installation location for a plurality of electronic locks.

According to a first aspect, it is provided a method for assigning an installation location for each one of a plurality of electronic locks, each comprising a radio transceiver, the method being performed in a position determiner. The method comprises: determining a common coordinate system; obtaining a distance and a direction between a pair of electronic locks of the plurality of electronic locks, based on the radio transceivers of the pair of electronic locks; aligning the direction and origin to conform to the common coordinate system; storing an identifier of each electronic lock of the pair, the distance between the electronic locks and the direction between the electronic locks; determining, based on the obtained distances and directions, a derived map of the electronic locks of the pairs; obtaining a reference map comprising installation locations for electronic locks, the reference map covering an area in which the electronic locks are installed; and assigning, based on the derived map and the reference map, the identifier of each one of the electronic locks to one of the installation locations in the reference map by matching the derived map and the reference map.

The method may further comprise, prior to the determining a derived map: repeating the obtaining a distance and a direction and storing, for a plurality of pairs of electronic locks.

The method may further comprise: determining that the distance between the pair of electronic locks is less than a threshold distance. In this case, the storing is only performed when the distance between the pair of electronic locks is less than the threshold distance.

The method may further comprise: selecting a reference node, being one electronic lock of the plurality of electronic locks. In this case, the determining the common coordinate system comprises determining the common coordinate system in relation to the reference node.

The derived map may be in the form of a graph structure where each node in the graph represents an electronic lock, and edges in the graph represent distances between electronic locks. In this case, the reference map is in the form of a graph structure where each node in the graph represents an installation location, and edges in the graph represent distances between the installation locations.

The assigning may comprise mapping the derived map with the reference map.

Each radio transceiver may support ultra-wideband, UWB.

Each radio transceiver may support Bluetooth low energy, BLE.

The reference map may comprises data for each installation locations indicating which zero or more other installation locations are within line-of-sight.

According to a second aspect, it is provided a position determiner for assigning an installation location for each one of a plurality of electronic locks, each comprising a radio transceiver. The position determiner comprises: processing circuitry; and memory circuitry storing instructions that, when executed by the processing circuitry, cause the position determiner to: determine a common coordinate system; obtain a distance and a direction between a pair of electronic locks of the plurality of electronic locks, based on the radio transceivers of the pair of electronic locks; align the direction and origin to conform to the common coordinate system; store an identifier of each electronic lock of the pair, the distance between the electronic locks and the direction between the electronic locks; determine, based on the obtained distances and directions, a derived map of the electronic locks of the pairs; obtain a reference map comprising installation locations for electronic locks, the reference map covering an area in which the electronic locks are installed; and assign, based on the derived map and the reference map, the identifier of each one of the electronic locks to one of the installation locations in the reference map by matching the derived map and the reference map.

According to a third aspect, it is provided a computer program for assigning an installation location for each one of a plurality of electronic locks, each comprising a radio transceiver. The computer program comprises computer program code which, when executed on a position determiner causes the position determiner to: determine a common coordinate system; obtain a distance and a direction between a pair of electronic locks of the plurality of electronic locks, based on the radio transceivers of the pair of electronic locks; align the direction and origin to conform to the common coordinate system; store an identifier of each electronic lock of the pair, the distance between the electronic locks and the direction between the electronic locks; determine, based on the obtained distances and directions, a derived map of the electronic locks of the pairs; obtain a reference map comprising installation locations for electronic locks, the reference map covering an area in which the electronic locks are installed; and assign, based on the derived map and the reference map, the identifier of each one of the electronic locks to one of the installation locations in the reference map by matching the derived map and the reference map.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIGS. 2A-B are schematic diagrams illustrating how a derived map can be aligned to a coordinate system;

FIGS. 3A-B are schematic diagrams illustrating how a true position of an electronic lock can be determined;

FIG. 4 is a schematic diagram illustrating how the derived map is mapped to the reference map;

FIGS. 5A-B are flow charts illustrating embodiments of methods for assigning an installation location for each one of a plurality of electronic locks;

FIG. 6 is a schematic diagram illustrating components of the position determiner of FIG. 1 according to one embodiment; and

FIG. 7 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, the process of determining installation locations for electronic locks is greatly improved. Each lock has a radio transceiver, e.g. based on ultra-wideband (UWB). A derived map is determined based on distance and direction measurements between pairs of electronic locks. The derived map comprises distances and directions between the electronic lock 12 in a common coordinate system. A reference map is obtained, comprising installation locations for electronic locks. The reference map can e.g. be based on a floorplan. The derived map is then mapped to the reference map, after which the installation location for each electronic lock, in the reference map, is determined.

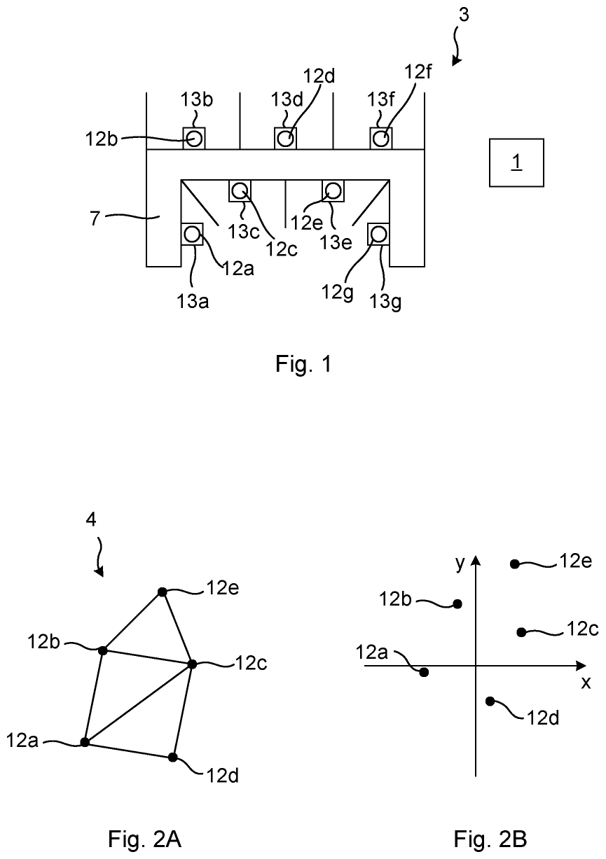

FIG. 1 is a schematic diagram illustrating an environment in which embodiments presented herein can be applied. It is shown a floor plan of a physical location 3 that comprises a plurality of electronic locks 12a-g for securing access to respective protected physical spaces, here provided by a corridor 7. Each electronic lock 12a-g is provided in a respective installation location 13a-g. The physical location can e.g. be a building, a floor of a building, etc.

Each electronic lock 12a-g comprises a radio transceiver. The radio transceiver allows a pair of corresponding electronic locks to determine their distance and relative direction to each other. For instance, each radio transceiver can be an ultra-UWB transceiver, that provides such capability. Alternatively or additionally, the radio transceiver supports BLE (Bluetooth low energy), or suitable cellular communication technology, such as 5G or 6G. It is to be noted that whenever the term ‘node’ is used herein, unless otherwise indicated, this refers to an electronic lock, door closer, or reader comprising a transceiver. Hence, ‘node’ and ‘electronic lock’ are used interchangeably herein.

The direction can be determined e.g. using angle-of-arrival (AoA) or phase difference of arrival (PDoA).

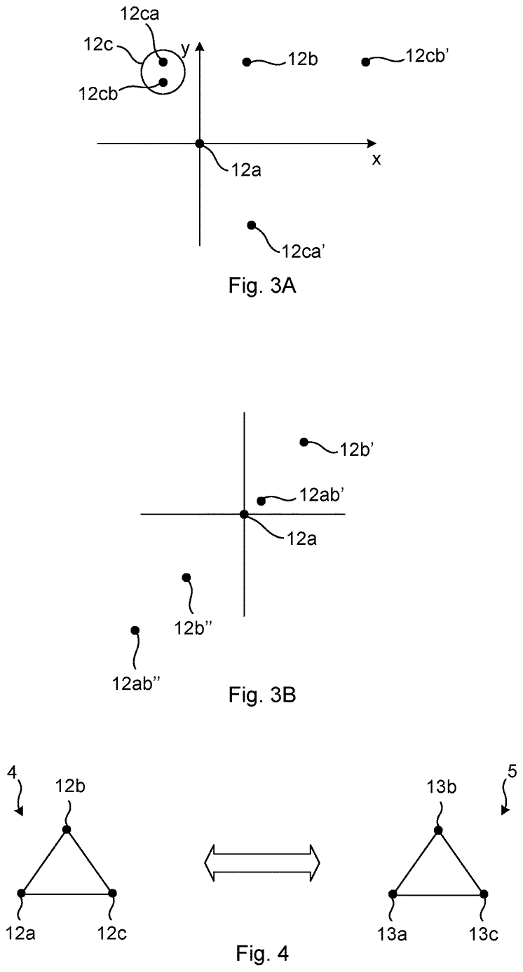

AoA is also known as the direction of arrival. This metric can be obtained using the receiver's amplitude response or the phase difference of arrival using at least two antennas at the receiver. More than two antennas can be provided to increase certainty and/or accuracy of determining direction. The AoA measurement can be based on beamforming. This method compares the signal strength received from each antenna simultaneously with the antenna pattern, and the transmitter's direction can be determined. It is to be noted that if there are only two receiving antennas, the AoA algorithm has result in two possible values for the direction to the other node. The correct value can be determined e.g. based on the procedure illustrated in FIGS. 3A-B that is described below.

PDoA exploits the received signal's phase information at the reception antennas. An array of antennas is used, where adjacent antennas are separated with a fixed distance. PDoA is determined as the difference in phase received by the antennas in the array due to the propagation distance from the signal source, such that each antenna in the array observes a phase shift of the signal. The physical distance between the antennas in the array and the antenna array design is then used to determine the PDoA.

The wave propagation is considered a plane wave in the far field and does not change by increasing the distance from the point source, which is ideal information for the PDoA calculation. In a two-antenna system, each antenna takes turns in the measuring phase. The two receiving antennas in the array are within ½ wavelength (gives a phase difference of 180 degrees) to determine which antenna is closer to the transmitter.

When the antennas are spaced at ½ wavelength, the phase difference will fall from 0 degrees (−180,180) degrees. The wrong measurement is unambiguous, as the lowest magnitude phase difference is always correct.

The distance can be determined e.g. using propagation time, time difference of arrival (TDoA) or received signal strength (RSS).

Propagation time the time a radio signal takes to travel between two nodes. Depending on the time synchronization between the two nodes, it can be time of arrival (ToA) or TDoA. TOA is based on a calculation of the time of arrival from the node. Depending on the time-based measurement and the clock synchronisation requirement, this type of measurement can be based on one-way propagation or round-trip propagation, where the round-trip propagation, based on two-way ranging, does not rely on synchronisation of clocks in the two nodes.

According to embodiments presented herein, based on the direction and distance between each pair of electronic locks 12a-g, a derived map is determined that defines the geometric relationship (distance and direction) between the electronic locks 12a-g. Another input is a reference map, that can be based on a floorplan or similar, that defines the installation locations 13a-g for electronic locks 12a-g.

A position determiner 1 is provided to determine in which (potential) installation location 13a-g that each electronic lock 12a-g is installed, based on matching the derived map 4 and the reference map 5. The position determiner 1 can be provided in the form of a server, (an application/app executing in) a smartphone, or any other computer device that is capable of performing embodiments of the methods described below for determining an installation location for each electronic lock 12a-g,

FIGS. 2A-B are schematic diagrams illustrating how a derived map 4 can be aligned to a coordinate system. When using UWB radios, each node knows the position of its neighbours in their own local coordinate system. For a set of nodes in a network, to detect the position of each node, a common coordinate system is used in which each node has its coordinates. While the distance between two nodes does not change between coordinate systems, the coordinates for all nodes may need to be rotated and/or translated to conform to a particular coordinate system.

Consider two nodes, 12a and 12b. In order to adjust the coordinate system of node 12b to have the same direction as the coordinate system of node 12a, node 12b needs to rotate its coordinate system. After detecting the neighbour's position (x, y) coordinates, the direction of the node's local coordinate system is converted to the direction of the common coordinate system. This adjustment angle a is obtained from the orientation information of node 12b.

The new coordinates for each node, after rotation, are given by:

x_new=x_old*cos(α)+y_old*sin(α)

y_new=−x_old*sin(α)+y_old*cos(α)

This approach converts the node's coordinate in a local coordinate system to a common coordinate system, enabling that a network of nodes are built in the common coordinate system even when the measurements are based on a local coordinate system.

FIGS. 3A-B are schematic diagrams illustrating how a true position of an electronic lock can be determined. When two antennas are used for determining direction, the direction can be one of two possible values. Consequently, the location of a neighbouring node can be in one of two possible positions—a true position and a false position. It will now be described two procedures in which the true position can be determined.

In a first procedure, illustrated by FIG. 3A, the true position can be determined using a triangulation algorithm. This procedure can be used when there are two or more neighbours with a known position. There are here a first node 12a, a second node 12b, and a third node 12c. Both the first node 12a and the second node 12b have known positions and are neighbours to a third node 12c, for which the true position is to be determined.

From the first node 12a, there are two possible positions 12ca, 12ca′ of the third node 12c. Analogously, from the second node 12b, there are two possible positions 12cb, 12cb′ of the third node. The location of the third node 12c can then be determined as the location where estimates of the third node 12c, from both the first node 12a and the second node 12b, coincide (within a margin of error). The position for the third node 12c can then be determined as the centroid of those two close points 12ca, 12cb. Alternatively, the position of the third node 12c is determined as a weighted average of the two close points. Alternatively, the position of the third node 12c is determined to be the position of one of the two close points.

It is to be noted that more estimates for the third node can be found using additional nodes.

FIG. 3B illustrates a procedure for determining the true position of a node when there is only a first node 12a with a known position. FIG. 3B is provided in the coordinate system of the first node 12a, whereby the known position of the first node 12a is in the origin.

If a first node 12a and a second node 12b are neighbours, then the two nodes will have information about each other. Specifically, the first node 12a has two estimates 12b′, 12b″ of the second node.

The orientation of the second node 12b in relation to the first node 12a estimated, and the position of the first node is in this procedure assumed to be determined to always be at an offset from the second node 12b. Thus, the mirror estimate of the first node 12a from the second node 12b can be neglected. This assumption of the determination of the position of the first node 12a from the second node 12b can e.g. be based on orientation of the second node, where only one of two possible positions is possible.

According to the above, there are two estimates 12b′, 12b″ of the position of the second node 12b from the first node 12a. Furthermore, there are two estimates 12ab′, 12ab″ that can be deduced for the position of the first node 12a from the second node 12b, where each estimate is an (the same) offset from the respective estimate 12b′, 12b″ of the position of the second node 12b. In this example, the offset is an offset downwards and to the left.

The estimate 12ab′ of the first node 12a that is close to the known position of the first node 12a (i.e. the origin) is then used to determine which one of the estimates 12b′, 12b″ of the second node 12b that was used to estimate the best estimate of the position of the first node 12a. In this case, this was the estimate 12b′ of the second node 12b on the top right. It can thus be deduced that this estimate 12b′ of the second node 12b on the top right that corresponds to the true position of the second node 12b.

As this approach works with certain assumptions, this is only taken during the worst case, when a node has only a single neighbour. Also, this approach estimates the first neighbour position after picking the reference node or based on the pre-defined reference node.

FIG. 4 is a schematic diagram illustrating how the derived map is mapped to the reference map. The derived map 4 here comprises three electronic locks 12a-c as nodes that the reference map 5 comprises three installation location 13a-c.

The mapping algorithm aims at mapping each electronic lock 13a-c in the derived map 4 to an installation location 13a-c in the reference map 5. This will result in a list of installed electronic locks 12a-c with assigned installation location 13a-c. The complexity of this mapping can be reduced if both the derived map 4 and the reference map 5 are in the form of graph structures, as shown in FIG. 4. The graph of the derived map is here denoted G and the graph of the reference map 5 is here denoted G1. A graph structure is a concept in discrete mathematics where there are a number of nodes (also known as vertices). Between at least some of the nodes, there are edges (i.e. lines) whose length is representative of a certain metric. For the derived map 4, the nodes represent electronic locks 12a-c, and the edges represent distance between the two connected nodes. For the reference map 5, the nodes represent installation locations 13a-c of electronic locks 12a-c and the edges represent distance between two connected nodes.

The graph structure of the reference map 5 can be derived from a floorplan (see e.g. FIG. 1) based on a list of 2D coordinates of each installation location. These coordinates are all provided in one coordinate system. One installation location can act as a reference node. The reference node is then placed in the origin and defines the rotational direction as well as the origin of the coordinate system. Optionally, each installation location comprises data on orientation in the coordinate system, e.g. in degrees, radians or north, north-east, east, etc., indicating a facing direction of an electronic lock, when installed. Optionally, the reference map 5 comprises data on what node pairs are within (and/or are not within) line-of-sight (LoS). LoS is usually needed for accurate UWB positioning, whereby node pairs that are not within LoS can be disregarded as possible pairs when generating the derived map 4 and/or mapping the derived map 4 against the reference map 5. Optionally, node pairs that are at a distance from each other less than a threshold distance are considered to give sufficiently reliable data for generating the derived map and are considered to be neighbouring nodes. Furthermore the threshold distance can be configured such that neighbouring electronic locks on the same side of a corridor are excluded, since, at least in UWB, the direction measurements can be off due to multipath transmissions reflecting off the opposite wall of the corridor. One value of the threshold distance that has been found to be a good balance is about twice the width of a corridor of the installation locations. When the threshold distance is applied, node pairs that are further away from each other are not considered neighbouring. Such a threshold can e.g. be set to be a few metres, e.g. a value between 5 and 10 metres.

The graph for the reference map 5 can be formed based on the floorplan. The graph G1 (N, E) here denotes the graph for the reference map. Graph Gi comprises a set of nodes N as the installation location, and E represents edges of the graph Gi where:

If nodes i, j∈N, then Eᵢⱼ∈E under the optional condition(s) that:
i and j are opposite each other, i.e. not adjacent (which can be determined based on their orientations). This condition can be ignored if there are not opposite nodes at all
i and j are one hop LoS neighbours, and
the distance between i and j is less the threshold distance

Each node N has as an associated position attribute, which is the 2D coordinates relative to a reference node in the graph G1, which is located in the origin.

Each edge E has an associated weight, i.e. length, representing the distance between the nodes.

The goal of the mapping algorithm is to pattern match the two graphs G, Gi and find the node-to-node mapping from that.

Here now follows more details in how the graph matching and node mapping can be achieved between the graphs G, G1.

Two graphs are same if they have same number of nodes and edges are same with its weight. Nevertheless, if two graphs do not have the same number of nodes (e.g. because of that the reference graph has fewer nodes caused by nodes has been filtered because of non LoS), then the matching algorithm can still work by removing the nodes from the derived map that have a specific error over a threshold. The graph structure is an effective tool for representation and analysis, the exact graph matching or detecting the graph isomorphism won't be an appropriate solution here, since the coordinates obtained from the positioning algorithm is not accurate. To handle this situation, all nodes in the network are traversed to find a node that is close to a node in the other graph. The position attributes in terms of the coordinates are compared.

The matching algorithm aims at finding a match between the nodes of the two graphs G, G1 with the smallest matching error. The matching error is defined as the discrepancy between each pair of matched nodes and their edges in the two graphs.

The matching algorithm iterates through each node by least distance between the two nodes. After finding the first match of a node, the edges of those nodes are compared. The number of edges and the edge weights are compared, and an error weight is calculated.

Each node is mapped to the node on the other graph which has the smallest error weight mapped. This procedure iterates until all nodes and their possible matches have been compared.

Given two graphs G (N, E) and G1 (N1, E1), an n×m matrix P is generated, where n and m is the number of nodes in graph G and G1. In one embodiment, n and m have the same value, i.e. the number of electronic locks is the same as the number of installation locations 13. Alternatively the number of installation locations can be greater than the number of electronic locks. Each element Pᵢⱼ of P is the distance between the nodes i in G and j in G1. A mapping matrix B of dimension n×m holds the most promising node-to-node mapping. In each row of B, the element with the lowest error weight in ta corresponding row of P is given the value 1, and all other elements in the row in B are given the value 0, resulting in a mapping between the nodes in G and G1 where the value is 1. Next, the edges are evaluated. One factor in this evaluation is to compare the same number of edges for the corresponding nodes in G and G1. Another factor is to compare the weights of the edges for the corresponding nodes in G and G1. An aggregate of these factors, optionally including the distance between the corresponding nodes, is calculated to yield an error weight.

In the second iteration, the second smallest element in P is compared, and B matrix is updated accordingly. The error weights calculated, and the mapping with smallest error weight is preserved in B matrix. The algorithm proceeds until all nodes and possible mapping are traversed.

As explained above, the error weights are calculated as the sum of distance between the nodes (distance between their coordinates), difference between the weights of each edge.

When there is a reference node, the number of iterations is set depending on the number of nodes in the graph. Since, the reference is known in this case, the mapping is not complex, and it mainly depends on how accurate the derived graph is. The graph comparison contains checking the closeness to node coordinate in the derived graph to a node coordinate in the reference graph, corresponding to a straight comparison between the derived map 4 and the reference map 5 in FIG. 4.

In one embodiment, when there is no LoS between an electronic lock 12 and the reference node, the derived map can be built iteratively, where each new node has LoS with the reference node or a previous node having been added to the derived map.

After the mapping, the result is that the first electronic lock 12a is mapped to the first installation location 13a, the second electronic lock 12b is mapped to the second installation location 13b and the third electronic lock 12c is mapped to the third installation location 13c.

When there is no predefined reference node, the mapping procedure is more complex. The reference in the derived graph can be any one of the nodes and there is no common reference node between the derived map 4 and the reference map 5.

The reference map 5 is created using its reference. If the orientation of each installation location 13a-c is known, the graph can be altered by changing the origin node, resulting in a change coordinate system.

When the origin of a coordinate system is changed to correspond to another installation location 13, using a coordinate conversion rule, the new coordinates for the points or nodes are calculated. This process is repeated for all installation locations 13a-c. Hence, the number of reference graphs that are generated correspond to the number of nodes in the reference map 5.

In the example of FIG. 4, where there are three installation location 13a-c, three different reference graphs are thus generated, one with each installation location 13a-c being the reference point.

When a new reference node is selected for a graph, the coordinate system is rotated such that the orientation of the new reference node defines the orientation of the coordinate system. For instance, the coordinate system can be rotated such that the orientation of the reference node corresponds to 0 degrees, 90 degrees, etc., as long as the orientation of the reference node consistently corresponds to one direction in the coordinate system.

Once the set of reference graphs are generated, the derived map 4 is mapped against each one of the reference graphs according to the mapping algorithm described above. The mapping that results in the lowest overall error weight is selected as the end result of the mapping, after which each electronic lock is associated with an installation location.

Ambiguity can occur when mapping without any common reference and the floorplan is symmetrical. In this case, it can be difficult to determine in which direction the derived map 4 corresponds to the reference map 5. For example, if there are four nodes, with one node in each corner of a square, there are two ways in which they could be mapped to the reference map 5, and it is difficult to determine the correct one.

One way to solve this is to have a common reference between the reference map 5 and the derived map 4. This will make the ambiguity disappear.

One way is to have the person installing the locks input in which installation location 13 the first electronic lock 12 is installed, resulting in a common reference point for both the derived map 4 and the reference map 5.

Another way to do this could be that there is already a node in the surroundings with known location, e.g. a gateway or some other type of node, and this can be used as the origin for both the reference map 5 and the derived map 4.

Another way to do this could be that the person installing the locks has a phone or other equipment on his/her person that comprises a corresponding transceiver (e.g. UWB transceiver). The installer can then start off the installation by indicating to the installation app on the phone the location when one of the locks (e.g. the first installed lock) is installed, and this node will then be a common reference for the derived map 4 and the reference map 5. The installer can indicate the location of the lock using a floorplan (corresponding to the reference map) that is shown in an app of the phone of the user.

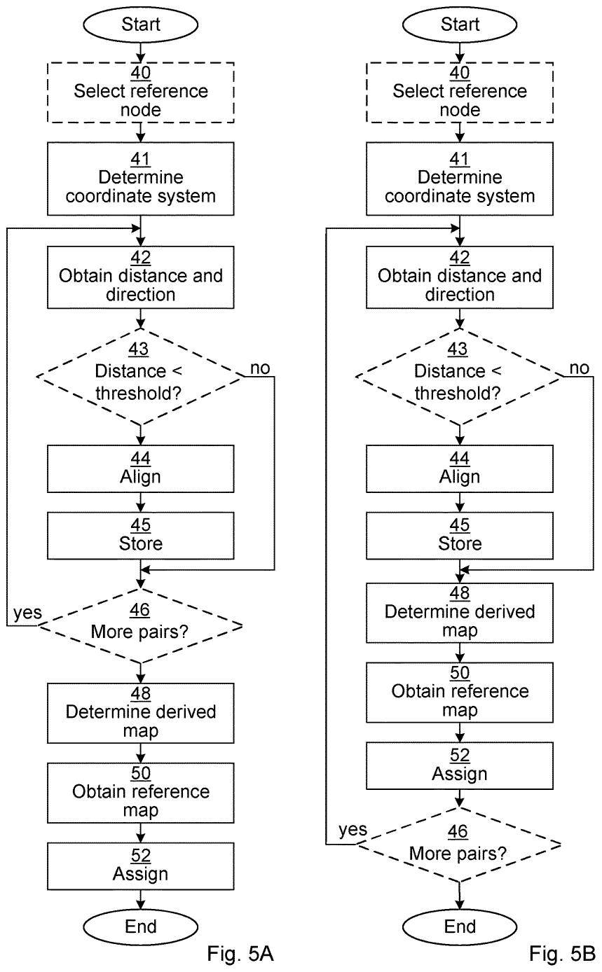

FIGS. 5A-B are flow charts illustrating embodiments of methods for assigning an installation location for each one of a plurality of electronic locks 12a-g. As explained above, each electronic lock 12a-g comprises a radio transceiver. For instance, each radio transceiver can support UWB. The method is performed in a position determiner 1. A difference between embodiments according to FIG. 5A and those according to FIG. 5B is that FIG. 5A illustrates an approach where the derived map is completed before mapping against the reference map, while FIG. 5B illustrates an iterative approach where, for each node, the derived map is updated and mapping against the reference map is performed.

In an optional select reference node step 40, the position determiner 1 selects a reference node, being one electronic lock of the plurality of electronic locks. In some cases (described above), a reference node is predetermined, in which case such a reference node is used here. In one embodiment, a reference node is selected, from the electronic locks, that has a number of opposite electronic locks that is greater than a threshold. Opposite electronic locks can be determined to be those that are within +−x degree (e.g. +−60 degree) range from directly opposite the electronic lock in question.

In an optional determine co-ordinate system step 41, the position determiner 1 determines a common coordinate system, that will be used for the derived map. When the select reference node step 40 is performed, the common coordinate system is determined in relation to the reference node, i.e. the reference node defines both the origin (translation) and direction (rotation) of the coordinate system.

In an obtain distance and direction step 42, the position determiner 1 obtains a distance and a direction between a pair of electronic locks of the plurality of electronic locks 12a-g, based on the radio transceivers of the pair of electronic locks. The distance and direction can be measured by the radio transceiver(s) as described above. In this step, an identifier of each electronic lock of the pair is also obtained.

In an optional conditional distance<threshold step 43, the position determiner 1 determines when the distance between the pair of electronic locks 12a-g is less than a threshold distance. When this is the case, the method proceeds to an optional align step 44 or a store step 45.

In the align step 44, the position determiner 1 aligns the direction and origin to conform to the common coordinate system. This step also comprises aligning the common coordinate system to a coordinate system of the reference map, i.e. to a mutual coordinate system between the derived map and the reference map. It is to be noted that there may be transformations between the direction and origin and the common coordinate system and/or transformations between the reference map and the common coordinate system.

In the store step 45, the position determiner 1 stores the identifier of each electronic lock 12a-g of the pair, the distance between the electronic locks 12a-g and the direction between the electronic locks 12a-g.

In an optional conditional more pairs step 46, as shown in FIG. 5A, the position determiner 1 determines whether there is any additional pair for which to determine distance and direction. It is to be noted that each pair can be evaluated from both two electronic locks 12 of that pair. If there is at least one additional pair, the method returns to the obtain distance and direction step 42. Otherwise, the method proceeds to a determine derived map step 48. When the optional conditional more pairs step 46 is not performed, the derived map can be built iteratively, node by node. In this case, the conditional more pairs step 46 is instead provided after the assign step 52, as illustrated in FIG. 5B.

In the determine derived map step 48, the position determiner 1 determines, based on the obtained distances and directions, a derived map 4 of the electronic locks 12a-g of the pairs, e.g. as explained above. The derived map 4 can be in the form of a graph structure, where each node in the graph represents an electronic lock 12a-g, and edges in the graph represent distances between electronic locks.

In an obtain reference map step 50, the position determiner 1 obtains a reference map 5 comprising installation locations 13a-g for electronic locks, the reference map 5 covering an area in which the electronic locks 12a-g are installed. The reference map 5 can be based on a floorplan covering the installation locations. The reference map can be obtained by reading local or remote memory or by requesting a local or remote resource to provide the reference map, which can be transmitted to the position determiner 1 over a communication network, such as an internet protocol (IP)-based network. As explained above, the reference map 5 can be in the form of a graph structure where each node in the graph represents an installation location 13a-g, and edges in the graph represent distances between the installation locations 13a-g.

Optionally, the reference map 5 comprises data for each installation locations 13a-g indicating which (zero or more) other installation locations 13a-g are within line-of-sight. In the mapping, this can be used to exclude pairs in the derived map that are not within line-of-sight.

In an assign step 52, the position determiner 1 assigns, based on the derived map 4 and the reference map 5, the identifier of each one of the electronic locks 12a-g to one of the installation locations 13a-g in the reference map 5. This is performed by matching the derived map 4 and the reference map 5. Optionally, the assigning 52 comprises mapping the derived map 4 with the reference map 5, as explained above, after which the assigning comprises associating the identifier of each electronic lock in the derived map 4 with the installation location of the corresponding node in the reference map 5.

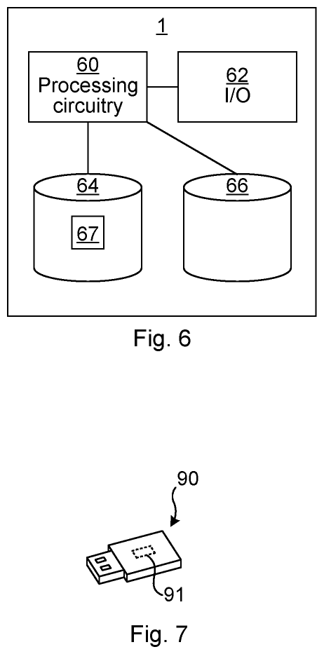

FIG. 6 is a schematic diagram illustrating components of the position determiner 1 of FIG. 1 according to one embodiment. Processing circuitry 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in memory circuitry 64, which can thus be a computer program product. The processing circuitry 60 could alternatively be implemented using an application specific integrated circuit (ASIC), field programmable gate array (FPGA), etc. The processing circuitry 60 can be configured to execute the method described with reference to FIG. 4 above.

The memory circuitry 64 can be any combination of random-access memory (RAM) and/or read-only memory (ROM). The memory circuitry 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processing circuitry 60. The data memory 66 can be any combination of RAM and/or ROM.

The position determiner 1 further comprises an I/O interface 62 for communicating with external and/or internal entities.

Other components of the position determiner 1 are omitted in order not to obscure the concepts presented herein.

FIG. 7 shows one example of a computer program product 90 comprising computer readable means. On this computer readable means, a computer program 91 can be stored in a non-transitory memory. The computer program can cause processing circuitry to execute a method according to embodiments described herein. In this example, the computer program product 90 is in the form of a removable solid-state memory, e.g. a Universal Serial Bus (USB) drive. As explained above, the computer program product could also be embodied in a memory of a device, such as the computer program product 64 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

Here now follows a list of enumerated embodiments from another perspective.
1. A method for assigning an installation location for each one of a plurality of electronic locks, each comprising a radio transceiver, the method being performed in a position determiner, the method comprising:
obtaining a distance and a direction between a pair of electronic locks of the plurality of electronic locks, based on the radio transceivers of the pair of electronic locks;
storing an identifier of each electronic lock of the pair, the distance between the electronic locks and the direction between the electronic locks;
determining, based on the obtained distances and directions, a derived map of the electronic locks of the pairs;
obtaining a reference map comprising installation locations for electronic locks, the reference map covering an area in which the electronic locks are installed; and
assigning, based on the derived map and the reference map, the identifier of each one of the electronic locks to one of the installation locations in the reference map.
2. The method according to embodiment 1, further comprising, prior to the determining a derived map:
repeating the obtaining a distance and a direction and storing, for a plurality of pairs of electronic locks.
3. The method according to embodiment 1 or 2, further comprising:
determining that the distance between the pair of electronic locks is less than a threshold distance; and wherein the storing is only performed when the distance between the pair of electronic locks is less than the threshold distance.
4. The method according to any one of the preceding embodiments, further comprising:
determining a common coordinate system; and
aligning the direction and origin to conform to the common coordinate system.
5. The method according to embodiment 4, further comprising:
selecting a reference node, being one electronic lock of the plurality of electronic locks;
and wherein the determining the common coordinate system comprises determining the common coordinate system in relation to the reference node.
6. The method according to any one of the preceding embodiments, wherein the derived map is in the form of a graph structure where each node in the graph represents an electronic lock, and edges in the graph represent distances between electronic locks; and
the reference map is in the form of a graph structure where each node in the graph represents an installation location, and edges in the graph represent distances between the installation locations.
7. The method according to embodiment 6, wherein the assigning comprises mapping the derived map with the reference map.
8. The method according to any one of the preceding embodiments, wherein each radio transceiver supports ultra-wideband, UWB.
9. The method according to any one of the preceding embodiments, wherein each radio transceiver supports Bluetooth low energy, BLE.
10. The method according to any one of the preceding embodiments wherein the reference map comprises data for each installation locations indicating which zero or more other installation locations are within line-of-sight.
11. A position determiner for assigning an installation location for each one of a plurality of electronic locks, each comprising a radio transceiver, the position determiner comprising:
processing circuitry; and
memory circuitry storing instructions that, when executed by the processing circuitry, cause the position determiner to:
obtain a distance and a direction between a pair of electronic locks of the plurality of electronic locks, based on the radio transceivers of the pair of electronic locks;
store an identifier of each electronic lock of the pair, the distance between the electronic locks and the direction between the electronic locks;
determine, based on the obtained distances and directions, a derived map of the electronic locks of the pairs;
obtain a reference map comprising installation locations for electronic locks, the reference map covering an area in which the electronic locks are installed; and
assign, based on the derived map and the reference map, the identifier of each one of the electronic locks to one of the installation locations in the reference map.
12. A computer program for assigning an installation location for each one of a plurality of electronic locks, each comprising a radio transceiver, the computer program comprising computer program code which, when executed on a position determiner causes the position determiner to:
obtain a distance and a direction between a pair of electronic locks of the plurality of electronic locks, based on the radio transceivers of the pair of electronic locks;
store an identifier of each electronic lock of the pair, the distance between the electronic locks and the direction between the electronic locks;
determine, based on the obtained distances and directions, a derived map of the electronic locks of the pairs;
obtain a reference map comprising installation locations for electronic locks, the reference map covering an area in which the electronic locks are installed; and
assign, based on the derived map and the reference map, the identifier of each one of the electronic locks to one of the installation locations in the reference map.
13. A computer program product comprising a computer program according to embodiment 12 and a computer readable means comprising non-transitory memory in which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method for assigning an installation location for each one of a plurality of electronic locks each comprising a radio transceiver, the method being performed in a position determiner the method comprising:
determining a common coordinate system;
obtaining a distance and a direction between a pair of electronic locks of the plurality of electronic locks based on the radio transceivers of the pair of electronic locks;
aligning the direction and an of the obtained distance and direction to conform to the common coordinate system;
storing an identifier of each electronic lock of the pair of electronic locks, the distance between the pair of electronic locks, and the direction between the pair of electronic locks
determining based on the obtained distance and direction, a derived map of the electronic locks
obtaining a reference map comprising installation locations for electronic locks, the reference map covering an area in which the plurality of electronic locks are installed; and
assigning based on the derived map and the reference map each identifier of the plurality of electronic locks to a corresponding installation location in the reference map by matching the derived map and the reference map.

2. The method according to claim 1, further comprising, prior to the determining a derived map:
repeating the obtaining a distance and a direction and the storing for a plurality of pairs of the plurality of electronic locks.

3. The method according to claim 1, further comprising:
determining that the distance between the pair of electronic locks is less than a threshold distance;
wherein the storing is only performed when the distance between the pair of electronic locks is less than the threshold distance.

4. The method according to claim 1, further comprising:
selecting a reference node, being one electronic lock of the plurality of electronic locks; and
wherein the determining a common coordinate system comprises determining the common coordinate system in relation to the reference node.

5. The method according to claim 1, wherein:
the derived map is a first graph where each node in the first graph represents an one of the plurality of electronic locks and edges in the first graph represent distances between the electronic locks; and
the reference map is second graph structure where each node in the second graph represents one of the installation locations, and edges in the second graph represent distances between the installation locations.

6. The method according to claim 5, wherein the assigning comprises mapping the derived map with the reference map.

7. The method according to claim 1, wherein each radio transceiver supports ultra-wideband, UWB.

8. The method according to claim 1, wherein each radio transceiver supports Bluetooth low energy, BLE.

9. The method according to claim 1. wherein the reference map comprises data for each of the installation locations indicating which zero or more other of the installation locations are within line-of-sight.

10. A position determiner for assigning an installation location for each one of a plurality of electronic locks, each comprising a radio transceiver, the position determiner comprising:
processing circuitry; and
memory circuitry storing instructions that, when executed by the processing circuitry, cause the position determiner to:
determine a common coordinate system;
obtain a distance and a direction between a pair of electronic locks of the plurality of electronic locks, based on the radio transceivers of the pair of electronic locks;
align the direction and an origin of the obtained distance and direction to conform to the common coordinate system;
store an identifier of each electronic lock of the pair of electronic locks. the distance between the pair of electronic locks, and the direction between the pair of electronic locks;
determine, based on the obtained distance and direction, a derived map of the electronic locks;
obtain a reference map comprising installation locations for electronic locks, the reference map covering an area in which the plurality of electronic locks are installed; and
assign, based on the derived map and the reference map each identifier of the plurality of electronic locks to a corresponding installation location in the reference map by matching the derived map and the reference map.

11. A non-transitory computer readable medium storing a computer program for assigning an installation location for each one of a plurality of electronic locks, each comprising a radio transceiver, the computer program comprising computer program code which, when executed on a position determiner, causes the position determiner to:
determine a common coordinate system;
obtain a distance and a direction between a pair of electronic locks of the plurality of electronic locks based on the radio transceivers of the pair of electronic locks;
align the direction and an origin of the obtained distance and direction to conform to the common coordinate system;
store an identifier of each electronic lock of the pair of electronic locks, the distance between the pair of electronic locks, and the direction between the pair of electronic locks;
determine, based on the obtained distance and direction, a derived map of the electronic locks;
obtain a reference map comprising installation locations for electronic locks, the reference map covering an area in which the plurality of electronic locks are installed; and
assign, based on the derived map and the reference map each identifier of the plurality of electronic locks to a corresponding installation location in the reference map (5) by matching the derived map (4) and the reference map (5).

12. (canceled)
